(19) United States
(12) Patent Application Publication
(10) Pub. No.: US 2025/0244860 A1
(43) Pub. Date: Jul. 31, 2025

(54) MATERIAL EDITING

(71) Applicant: Beijing Zitiao Network Technology Co., Ltd., Haidian District, Beijing (CN)

(72) Inventors: Xinyi He, Beijing (CN); Mengjie Zhou, Beijing (CN); Mingyuan Wang, Beijing (CN); Jiahao Chen, Beijing (CN)

(21) Appl. No.: 19/041,119

(22) Filed: Jan. 30, 2025

(30) Foreign Application Priority Data
Jan. 31, 2024 (CN) 202410140005.8

(51) Int. Cl. G06F 3/04845

(52) U.S. Cl. CPC G06F 3/04845

(57) ABSTRACT

The disclosure relates to a method, an apparatus, an electronic device, and a computer-readable storage medium for material editing. The method includes: presenting a target chat interface, wherein the target chat interface is a chat window interface of a material editing robot and at least one user, the target chat interface comprises at least one material corresponding to the at least one user, and the at least one material is a material with a same shooting subject; presenting, in the target chat interface, a material editing instruction for the at least one material sent by a user to the material editing robot; and presenting, in the target chat interface, at least one material editing result replied by the material editing robot, wherein the at least one material editing result is obtained by the material editing robot editing the at least one material based on the material editing instruction.

### CROSS-REFERENCE

The present application claims priority to Chinese Patent Application No. 202410140005.8 filed on Jan. 31, 2024, and entitled “METHOD, APPARATUS, ELECTRONIC DEVICE, AND COMPUTER-READABLE STORAGE MEDIUM FOR MATERIAL EDITING”, the entirety of which is incorporated herein by reference.

### FIELD

The present disclosure relates to the field of image editing technology, and in particular, to material editing.

### BACKGROUND

In the related art, when a user needs to perform material editing (such as beautifying or editing into a film, or the like) on a large number of materials (such as pictures or videos) shot on a certain shooting subject (such as a travel subject, an art exhibition subject, an animal observation subject, a building visiting subject, or the like), it is necessary to first find materials that can better express the shooting subject from the large number of materials as target materials for material editing, and then perform a series of complex material editing operations such as beautifying tasks in the target materials, and splicing and editing the target materials (highlight segment extraction, highlight segment splicing, adding transition processing, and adding an effect), to finally generate material editing results.

In order to obtain a high-quality material editing result, it is not only necessary for the user to select materials that can better express the shooting subject from a large number of materials, but also for the user to have relatively rich material editing experiences, otherwise the material editing process will be time-consuming, resulting in an increase in time cost and a low quality of the material editing result.

### SUMMARY

To solve the above technical problems or at least partially solve the above technical problems, the present disclosure provides a method, an apparatus, an electronic device, a storage medium, and a program product for material editing.

According to a first aspect of the embodiments of the present disclosure, a method for material editing is provided. The method comprises: presenting a target chat interface, where the target chat interface is a chat window interface of a material editing robot and at least one user, the target chat interface comprises at least one material corresponding to the at least one user, and the at least one material is a material with a same shooting subject; presenting, in the target chat interface, a material editing instruction for the at least one material sent by a user to the material editing robot; and presenting, in the target chat interface, at least one material editing result replied by the material editing robot, where the at least one material editing result is obtained by the material editing robot editing the at least one material based on the material editing instruction.

In some embodiments of the present disclosure, the material editing instruction is an instruction for editing a target object; and presenting, in the target chat interface, at least one material editing result replied by the material editing robot comprises: presenting, in the target chat interface, a plurality of images and first prompt information replied by the material editing robot, where the first prompt information is configured to prompt a user to select, from the plurality of images, an image corresponding to the target object, and each image is an image comprising an object extracted by the material editing robot from the at least one material; and in response to a trigger operation of a user to select a target image corresponding to the target object, presenting the at least one material editing result.

In some embodiments of the present disclosure, in response to the trigger operation of the user to select the target image corresponding to the target object, presenting the at least one material editing result comprises: in response to a trigger operation of a user to select the target image corresponding to the target object, presenting, in the target chat interface, at least one candidate material and second prompt information replied by the material editing robot, where each candidate material is a material comprising the target object in the at least one material, and the second prompt information is configured to prompt a user to select, from the at least one candidate material, a material required to be edited; and in response to a trigger operation of a user to select the target material from the at least one candidate material, presenting the at least one material editing result, where the at least one material editing result is obtained by the material editing robot editing the target material.

In some embodiments of the present disclosure, the material editing instruction is a material clipping instruction, and the editing is material clipping, and the at least one material editing result is at least one clipping result; and presenting, in the target chat interface, at least one material editing result replied by the material editing robot comprises: presenting, in the target chat interface, the at least one clipping result and at least one operation identifier, where each operation identifier is configured to indicate any of the following: playing a target clipping result from the at least one clipping result; storing the target clipping result from the at least one clipping result; publishing the target clipping result from the at least one clipping result to an information publishing interface of a target social application; re-performing material clipping on the target object in the at least one material to generate a clipping result; or jumping to a video editing application to perform secondary editing on the target clipping result from the at least one clipping result.

In some embodiments of the present disclosure, the material editing instruction is an object beautifying instruction, and the editing is material beautifying, the at least one material editing result is at least one beautified result, and presenting, in the target chat interface, the at least one material editing result replied by the material editing robot comprises: presenting, in the target chat interface, the at least one beautified result and at least one operation label, where each operation label is configured to indicate any of the following: storing a target beautified result from the at least one beautified result; publishing the target beautified result from the at least one beautified result to an information publishing interface of a target social application; storing a beautifying parameter corresponding to the target beautified result from the at least one beautified result; re-performing material beautifying on the target object from the at least one material to generate a beautified result; or jumping to a video editing application to perform secondary editing on the target beautified result from the at least one beautified result.

In some embodiments of the present disclosure, after presenting, in the target chat interface, the at least one beautified result and the at least one operation label, the method further comprises: in response to a trigger operation on a target operation label from the at least one operation label, storing the beautifying parameter corresponding to the target beautified result as a target beautifying parameter for performing material processing on the target object, where the material processing comprises at least one of the following: material beautifying or material clipping.

In some embodiments of the present disclosure, after storing the beautifying parameter corresponding to the target beautified result as the target beautifying parameter for performing material processing on the target object, the method further comprises: presenting, in the target chat interface, a material clipping instruction for the target object sent by the user to the material editing robot; and presenting, in the target chat interface, at least one material clipping result replied by the material editing robot, where the at least one material clipping result is obtained by the material editing robot performing material clipping on the at least one material based on the material clipping instruction, and the target object in the at least one material clipping result has been beautified based on the target beautifying parameter.

In some embodiments of the present disclosure, before presenting the target chat interface, the method further comprises: in response to a trigger operation of a user to add the material editing robot to the chat window, presenting, in the target chat interface, a target message sent by the material editing robot; where the target message comprises a function introduction of the material editing robot in a text form, and the target message further comprises at least one of the following: a function introduction of the material editing robot in a video form; or a question of the material editing robot about a chat topic of the target chat interface.

According to a second aspect of the embodiments of the present disclosure, an apparatus for material editing is provided. The apparatus comprises: a presenting module configured to present a target chat interface, where the target chat interface is a chat window interface of a material editing robot and at least one user, the target chat interface comprises at least one material corresponding to the at least one user, and the at least one material is a material with a same shooting subject; present, in the target chat interface, a material editing instruction for the at least one material sent by a user to the material editing robot; and present, in the target chat interface, at least one material editing result replied by the material editing robot, where the at least one material editing result is obtained by the material editing robot editing the at least one material based on the material editing instruction.

In some embodiments of the present disclosure, the material editing instruction is an instruction for editing a target object; and the presenting module is configured to present, in the target chat interface, a plurality of images and first prompt information replied by the material editing robot, where the first prompt information is configured to prompt a user to select, from the plurality of images, an image corresponding to the target object, and each image is an image comprising an object extracted by the material editing robot from the at least one material; and in response to a trigger operation of a user to select a target image corresponding to the target object, present the at least one material editing result.

In some embodiments of the present disclosure, the presenting module is configured to, in response to a trigger operation of a user to select the target image corresponding to the target object, present, in the target chat interface, at least one candidate material and second prompt information replied by the material editing robot, where each candidate material is a material comprising the target object in the at least one material, and the second prompt information is configured to prompt the user to select, from the at least one candidate material, a material required to be edited; and in response to a trigger operation of a user to select the target material from the at least one candidate material, present the at least one material editing result, where the at least one material editing result is obtained by the material editing robot editing the target material.

In some embodiments of the present disclosure, the material editing instruction is a material clipping instruction, and the editing is material clipping, and the at least one material editing result is at least one clipping result; and the presenting module is configured to present, in the target chat interface, the at least one clipping result and at least one operation identifier, where each operation identifier is configured to indicate any of the following: playing a target clipping result from the at least one clipping result; storing the target clipping result from the at least one clipping result; publishing the target clipping result from the at least one clipping result to an information publishing interface of a target social application; re-performing material clipping on the target object in the at least one material to generate a clipping result; or jumping to a video editing application to perform secondary editing on the target clipping result from the at least one clipping result.

In some embodiments of the present disclosure, the material editing instruction is an object beautifying instruction, and the editing is material beautifying, the at least one material editing result is at least one beautified result, the presenting module is configured to present, in the target chat interface, the at least one beautified result and at least one operation label, where each operation label is configured to indicate any of the following: storing a target beautified result from the at least one beautified result; publishing the target beautified result from the at least one beautified result to an information publishing interface of a target social application; storing a beautifying parameter corresponding to the target beautified result from the at least one beautified result; re-performing material beautifying on the target object from the at least one material to generate a beautified result; or jumping to a video editing application to perform secondary editing on the target beautified result from the at least one beautified result.

In some embodiments of the present disclosure, the apparatus further comprises a storing module configured to, after presenting, in the target chat interface, the at least one beautified result and the at least one operation label, in response to a trigger operation on a target operation label from the at least one operation label, store the beautifying parameter corresponding to the target beautified result as a target beautifying parameter for performing material processing on the target object, where the material processing comprises at least one of the following: material beautifying or material clipping.

In some embodiments of the present disclosure, the presenting module is further configured to, after storing the beautifying parameter corresponding to the target beautified result as the target beautifying parameter for performing material processing on the target object, present, in the target chat interface, a material clipping instruction for the target object sent by the user to the material editing robot; and present, in the target chat interface, at least one material clipping result replied by the material editing robot, where the at least one material clipping result is obtained by the material editing robot performing material clipping on the at least one material based on the material clipping instruction, and the target object in the at least one material clipping result has been beautified based on the target beautifying parameter.

In some embodiments of the present disclosure, the presenting module is further configured to, before presenting the target chat interface, in response to a trigger operation of a user to add the material editing robot to the chat window, present, in the target chat interface, a target message sent by the material editing robot; where the target message comprises a function introduction of the material editing robot in a text form, and the target message further comprises at least one of the following: a function introduction of the material editing robot in a video form; or a question of the material editing robot about a chat topic of the target chat interface.

According to a third aspect of the embodiments of the present disclosure, an electronic device is provided. The electronic device comprises a processor, a memory, and a computer program stored in the memory and executable on the processor. When the computer program is executed by the processor, the method for material editing according to the first aspect is performed.

According to a fourth aspect of the embodiments of the present disclosure, a computer-readable storage medium is provided. The computer-readable storage medium stores a computer program that, when executed by a processor, implements the method for material editing according to the first aspect.

According to a fifth aspect of the embodiments of the present disclosure, a computer program product is provided. The computer program product comprises a computer program. When the computer program product runs on a processor, the processor is caused to execute the computer program, to implement the method for material editing according to the first aspect.

According to a sixth aspect of the embodiments of the present disclosure, a chip is provided. The chip comprises a processor and a communication interface. The communication interface is coupled to the processor. The processor is configured to run program instructions, to implement the method for material editing according to the first aspect.

Compared with the prior art, the technical solution provided in the embodiments of the present disclosure has the following advantages. A target chat interface is presented, where the target chat interface is a chat window interface for a material editing robot and at least one user, the target chat interface comprises at least one material corresponding to the at least one user, and the at least one material is a material with a same shooting subject; in the target chat interface, a material editing instruction for the at least one material sent by a user to the material editing robot is presented; and in the target chat interface, at least one material editing result replied by the material editing robot is presented, where the at least one material editing result is obtained by the material editing robot editing the at least one material based on the material editing instruction. In this solution, the material editing robot with a material editing function is added to the chat window, so that the user may send the material editing instruction in the target chat interface. Thereby, the material editing robot edits the at least one material based on the material editing instruction to obtain at least one material editing result, and presents, in the target chat interface, the at least one material editing result replied by the material editing robot. In this way, when the user needs to edit a large number of materials shot on a certain shooting subject, there is no need to deeply analyze which materials can better express the shooting subject, and there is no need to manually find, from the at least one material, the target material that needs to be edited. This may reduce the time consumption. Moreover, the material editing result may be generated without the user manually performing a series of complex material editing operations on the target material, which may further reduce the time consumption. The user only needs to send the at least one shot material to the chat window, and send the material editing instruction in the target chat interface, to trigger the material editing robot to automatically edit the at least one material to obtain the at least one material editing result, thereby improving the efficiency of material editing and the quality of the material editing result.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

In order to more clearly illustrate the technical solutions in the embodiments of the present disclosure or in the prior art, the accompanying drawings for describing the embodiments or the prior art will be briefly described below. It is apparent that the accompanying drawings in the following description show merely some embodiments of the present disclosure, and a person of ordinary skill in the art may still derive other drawings from these accompanying drawings without creative efforts.

FIG. 1 is a schematic flowchart of a method for material editing according to an embodiment of the present disclosure;

FIG. 2 is a first schematic diagram of an interface for a method for material editing according to an embodiment of the present disclosure;

FIG. 3 is a second schematic diagram of an interface for a method for material editing according to an embodiment of the present disclosure;

FIG. 4 is a third schematic diagram of an interface for a method for material editing according to an embodiment of the present disclosure;

FIG. 5 is a fourth schematic diagram of an interface for a method for material editing according to an embodiment of the present disclosure;

FIG. 6 is a block diagram of a structure of an apparatus for material editing according to an embodiment of the present disclosure; and

FIG. 7 is a block diagram of a structure of an electronic device according to an embodiment of the present disclosure.

### DETAILED DESCRIPTION

In order to more clearly understand the above objectives, features, and advantages of the present disclosure, the solutions of the present disclosure are further described below. It should be noted that, without conflict, the embodiments of the present disclosure and the features in the embodiments may be combined with each other.

Many specific details are set forth in the following description to fully understand the present disclosure, but the present disclosure may also be implemented in other manners different from those described herein. Obviously, the embodiments described in the specification are merely some embodiments of the present disclosure, rather than all embodiments.

The terms “first” and “second” in the specification and claims of the present disclosure are intended to distinguish between similar objects, but do not necessarily indicate a specific order or sequence. It should be understood that the data used in such a way is interchangeable in proper circumstances so that the embodiments of the present disclosure can be implemented in orders in addition to the order illustrated or described herein. The objects distinguished by “first”, “second”, etc. are usually of the same type, and the number of objects is not limited. For example, the first object may be one or more. Moreover, “and/or” in the specification and claims indicate at least one of the associated objects. The character “/” generally indicates an “or” relationship between the associated objects.

The electronic device in the embodiments of the present disclosure may be a mobile electronic device or a non-mobile electronic device. The mobile electronic device may be a mobile phone, a tablet computer, a notebook computer, a palmtop computer, an in-vehicle electronic device, a wearable device, an ultra-mobile personal computer (UMPC), a netbook, a personal digital assistant (PDA), or the like. The non-mobile electronic device may be a personal computer (PC), a television (TV), an ATM, a self-service machine, or the like. They are not specifically limited in the embodiments of the present disclosure.

An execution subject of the method for material editing provided in the embodiments of the present disclosure may be the foregoing electronic device (including a mobile electronic device and a non-mobile electronic device), or may be a functional module and/or a functional entity in the electronic device that can implement the method for material editing. The specific implementation may be determined based on an actual use demand, which is not limited in the embodiments of the present disclosure.

The method for material editing provided in the embodiments of the present disclosure is described in detail below with reference to the accompanying drawings and through specific embodiments and application scenarios.

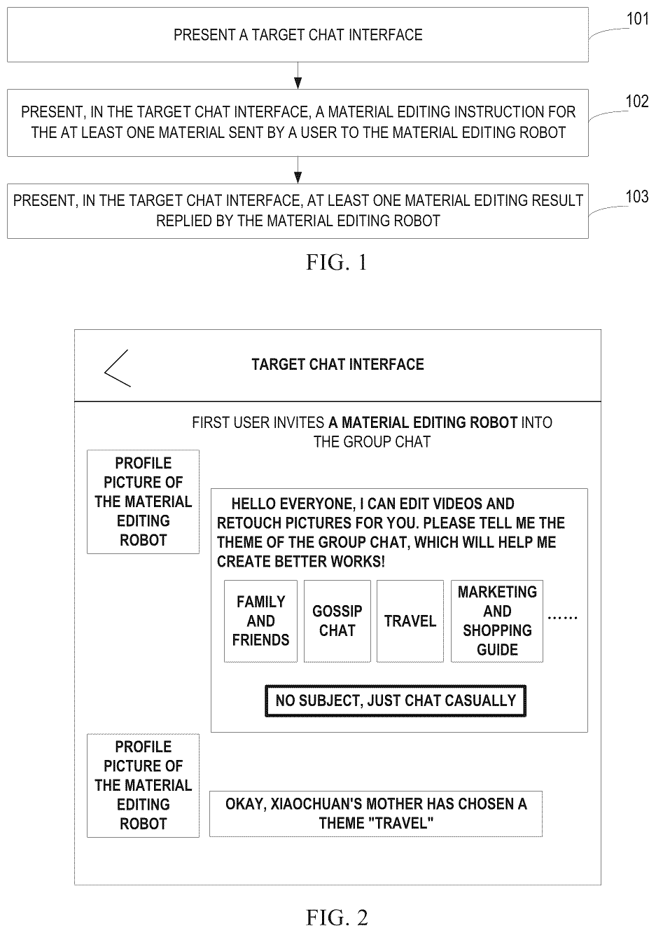

As shown in FIG. 1, an embodiment of the present disclosure provides a method for material editing. The method may include the following steps 101 to 103.

101. A target chat interface is presented.

The target chat interface is a chat window interface of a material editing robot and at least one user. The target chat interface comprises at least one material corresponding to the at least one user, and the at least one material is a material with a same shooting subject.

The at least one material may include the material of the at least one user, and the at least one material may be the material of a same scene shot by the at least one user. This may be specifically determined based on an actual situation, which is not limited here.

If the at least one material includes the material of the at least one user, any of the at least one material may include all users of the at least one user, or may include some users of the at least one user. This may be specifically determined based on an actual situation, which is not limited here.

If the at least one material is the material of the same scene shot by the at least one user, the at least one material may be a material of a specific scene shot from different angles and at different times, and the at least one material includes a same object in the scene. The same object may be a person, an animal, an article, a building, or the like. This may be specifically determined based on an actual situation, which is not limited here.

The at least one material is the material with the same shooting subject. The shooting subject may be a travel subject, an art exhibition subject, an animal observation subject, a building visiting subject, or the like. This may be specifically determined based on an actual situation, which is not limited here.

The at least one material may be associated materials, for example, the at least one material is materials presented in the target chat interface at the times close to each other, the at least one material is the materials with same location information, the at least one material is the material specified by the user for material editing, the at least one material is similar materials (with same location information or same landscape information), or there may be another relationship between/among the at least one material. This may be specifically determined based on an actual situation, which is not limited here.

The target chat interface may further include another material other than the at least one material. This may be specifically determined based on an actual situation, which is not limited here.

The target chat interface may be a chat interface of any instant social application. This may be specifically determined based on an actual situation, which is not limited here.

In some embodiments of the present disclosure, the material editing robot is a software development kit (SDK) integrated with a material clipping capability and presented in the target chat interface in a form of a robot.

In some embodiments of the present disclosure, the SDK may be installed in a background server or another server associated with the background server. This may be specifically determined based on an actual situation, which is not limited here. In this case, any user in the chat window may chat with the material editing robot.

The material editing robot may be automatically added to the chat window when the chat window is created, or may be added to the chat window by any of the at least one user through an adding operation. This may be specifically determined based on an actual situation, which is not limited here.

102. In the target chat interface, a material editing instruction for the at least one material sent by a user to the material editing robot is presented.

The user who sends the material clipping instruction may be any user. This may be specifically determined based on an actual situation, which is not limited here.

The material clipping instruction may be an instruction in a voice format or an instruction in a text format. This may be specifically determined based on an actual situation, which is not limited here.

The material editing instruction may be a material clipping instruction, an object beautifying instruction, or another instruction. This may be specifically determined based on an actual situation, which is not limited here.

For example, the at least one material is travel-related materials of at least one user, and the material editing instruction is a material clipping instruction. In this case, the material clipping instruction may specifically be “@Material editing robot, can you clip a video featuring me?”, “@Material editing robot, clip a video of checking in at a place of xx”, “@Material editing robot, clip a video according to a timeline, and do not forget to beautify the characters!” or the like. This may be specifically determined based on an actual situation, which is not limited here.

For example, the at least one material is travel-related materials of at least one user, and the material editing instruction is an object beautifying instruction. In this case, the object beautifying instruction may be “@Material editing robot, can you beautify me?”, “@Material editing robot, can you retouch my face?” or the like. This may be specifically determined based on an actual situation, which is not limited here.

103. In the target chat interface, at least one material editing result replied by the material editing robot is presented.

The at least one material editing result is obtained by the material editing robot editing the at least one material based on the material editing instruction.

When the at least one material is edited, all materials of the at least one material may be edited, or some of the at least one material may be edited.

A specific process of editing the at least one material may refer to the related art, and details are not described herein again.

When the material editing instruction is a material clipping instruction, due to a relatively large number of the at least one material, a process of editing (material clipping) includes: performing deduplication, highlight extraction, splicing, and the like on the at least one material. Deduplication is to remove duplicate materials with repeated content and poor shooting effect (poor light and shadow effect, poor composition effect, noisy sound, and poor definition) from the at least one material, to obtain first materials. Then, highlight extraction is performed on the first materials to extract a plurality of highlight segments, and the plurality of extracted highlight segments are spliced to obtain a material editing result (clipping result).

Highlight extraction is to remove an unstable shot, a noisy sound, and an incomplete picture from a material, and then extract a segment that can completely express a highlight event from the remaining material, that is, a highlight segment.

A process of extracting a highlight segment generally includes: first, slicing a material to obtain a plurality of slices; then scoring each frame in a target slice (any of the plurality of slices) to determine a frame with the highest score as a highlight frame; and then extending (extracting a predetermined number of consecutive video frames forward and/or backward) based on the highlight frame to obtain the highlight segment corresponding to the target slice.

The scoring is performed based on dimensions such as composition, color, and aesthetics of a video frame.

For example, if a 1-second highlight segment is required, 0.5 second of video frames before and after the highlight frame with the highest score may be selected to obtain the 1-second highlight segment.

A highlight event is a special plot in a video such as a person, an object, an action, a story, and/or a sound effect that attracts the audience. In different types of videos, different highlight events may be defined. For example, in a football match video, a goal, a tackle, and a save are defined as highlight events; and in a battle operation game video, a release action of each skill is defined as a highlight event. Compared with other plain parts in a video, a highlight event can arouse more interest and attention of people.

In some embodiments of the present disclosure, in a process of editing (material clipping), at least one clipping template may be further matched based on scene information (geographic information, environment information, time information, or the like) of the at least one material, and then a highlight segment required by each clipping template is obtained. The obtained highlight segments are spliced and combined to at least one clipping result according to a corresponding clipping template.

In some embodiments of the present disclosure, the material editing instruction is an instruction for editing a target object. If the material editing robot previously stores image information of the target object, the material editing robot directly screens the at least one material based on the stored image information of the target object to screen out at least one candidate material including the target object. If the material editing robot has not previously stored image information of the target object, the material editing robot first extracts an image of each object of a same type as the target object from the at least one material to obtain a plurality of images, then presents the plurality of images for a user to select, and after the user selects a target image corresponding to the target object from the plurality of images, screens the at least one material based on the target image to screen out at least one candidate material including the target object.

In some embodiments of the present disclosure, the foregoing step 103 may be specifically implemented by the following steps 103a and 103b.

103a. In the target chat interface, a plurality of images and first prompt information replied by the material editing robot are presented.

The first prompt information is configured to prompt a user to select, from the plurality of images, an image corresponding to the target object, and each image is an image comprising an object extracted by the material editing robot from the at least one material.

For example, the content of the first prompt information may be “Which one is the target object?”, “Please select the target object?”, or the like. This may be specifically determined based on an actual situation, which is not limited here.

103b. In response to a trigger operation of a user to select a target image corresponding to the target object, the at least one material editing result is present.

In the embodiments of the present disclosure, through the foregoing steps 103a and 103b, it can be ensured that the at least one material editing result is obtained by editing the target object, and interaction between the user and the material editing robot may be increased, so that user experience can be improved.

In some embodiments of the present disclosure, after determining the at least one candidate material from the at least one material, the material editing robot may further present, in the target chat interface, the at least one candidate material and material selection prompt information sent by the material editing robot, where the material selection prompt information is configured to prompt the user to select, from the at least one candidate material, a target material required to be edited; and then in response to a trigger operation of the user to select the target material from the at least one candidate material, the material editing robot edits the target material to obtain the at least one material editing result.

In some embodiments of the present disclosure, the foregoing step 103b may be specifically implemented by the following steps 103b1 and 103b2.

103b1. In response to a trigger operation of a user to select the target image corresponding to the target object, in the target chat interface, at least one candidate material and second prompt information replied by the material editing robot are presented.

Each candidate material is a material comprising the target object in the at least one material, and the second prompt information is configured to prompt the user to select, from the at least one candidate material, a material required to be edited.

In some embodiments of the present disclosure, if the material editing instruction is a material clipping instruction, the second prompt information is specifically configured to indicate the user to select, from the at least one candidate material, a material required to be clipped (clipped into a film or clipped to generate a video); or if the material editing instruction is an object beautifying instruction, the second prompt information is specifically configured to indicate the user to select, from the at least one candidate material, a material required to be material beautified.

The specific content of the second prompt information may be “Please select which of the following photos you want to edit?”, “Find 10 materials including the target object within the last 3 days, and please select a material required to be edited”, or the like. This may be specifically determined based on an actual situation, which is not limited here.

103b2. In response to a trigger operation of a user to select the target material from the at least one candidate material, the at least one material editing result is presented.

The at least one material editing result is obtained by the material editing robot by editing the target material.

The target material comprises one or more materials. This may be specifically determined based on an actual situation, which is not limited here.

In the embodiments of the present disclosure, the user participates in the material clipping process, and at least one candidate material that can be edited is provided to the user. The user selects the target material from the at least one candidate material based on the needs, and then the target material is edited to generate the at least one material editing result, so that user experience can be improved.

In some embodiments of the present disclosure, the material editing instruction is a material clipping instruction, and the editing is material clipping. The at least one material editing result is at least one clipping result. The foregoing step 103 may be specifically implemented by the following step 103c.

103c. In the target chat interface, the at least one clipping result and at least one operation identifier is presented.

Each operation identifier is configured to indicate any of the following: playing a target clipping result from the at least one clipping result; storing the target clipping result from the at least one clipping result; publishing the target clipping result from the at least one clipping result to an information publishing interface of a target social application; re-performing material clipping on the target object in the at least one material to generate a clipping result; or jumping to a video editing application to perform secondary editing on the target clipping result from the at least one clipping result.

The target clipping result may be one or more clipping results of the at least one clipping result. This may be specifically determined based on a requirement of the user, which is not limited here.

The target social application may be a social application to which the target chat interface belongs, or may be another social application other than the social application to which the target chat interface belongs. This may be specifically determined based on an actual situation.

If the at least one operation identifier includes a target operation identifier corresponding to “publishing the target clipping result of the at least one clipping result to an information publishing interface of a target social application”, the target operation identifier is associated with path information for jumping to the information publishing interface.

The video editing application may be any application with a material clipping function. This may be specifically determined based on an actual situation, which is not limited here.

In some embodiments of the present disclosure, third prompt information may be further presented in the target chat interface while the at least one clipping result and the at least one operation identifier are presented. The third prompt information is configured to prompt a user that the at least one clipping result has been generated. The user prompted by the third prompt information may be any user or all users. This may be specifically determined based on an actual situation, which is not limited here.

The specific text content of the third prompt information may be “The video is ready. Come and have a look!”, “@xx user, the video is ready. Come and have a look!”, “@xx user, the video is ready. Come and see whether it is beautiful?” This may be specifically determined based on an actual situation, which is not limited here.

In the embodiments of the present disclosure, by presenting the at least one operation identifier while presenting the at least one clipping result, it is convenient for a user to select a required operation identifier from the at least one operation identifier to perform corresponding processing on the at least one clipping result; and by presenting the third prompt information while presenting the at least one clipping result, it is convenient for a user to quickly determine that the clipped video has been completed, so that user experience can be improved.

In some embodiments of the present disclosure, the material editing instruction is an object beautifying instruction, and the editing is material beautifying. The at least one material editing result is at least one beautified result, and the foregoing step 103 may be specifically implemented by the following step 103d.

103d. In the target chat interface, the at least one beautified result and at least one operation label are presented. Each operation label is configured to indicate any of the following: storing a target beautified result from the at least one beautified result; publishing the target beautified result from the at least one beautified result to an information publishing interface of a target social application; storing a beautifying parameter corresponding to the target beautified result from the at least one beautified result; re-performing material beautifying on the target object from the at least one material to generate a beautified result; or jumping to a video editing application to perform secondary editing on the target beautified result from the at least one beautified result.

The target beautified result may be one or more of the at least one beautified result. This may be specifically determined based on an actual situation, which is not limited here.

In some embodiments of the present disclosure, a user may choose to publish the target beautified result to the information publishing interface, or may choose to publish the target clipping result to the information publishing interface. This may be specifically determined based on an actual situation, which is not limited here.

In some embodiments of the present disclosure, any user may operate one or more of the at least one operation label to perform corresponding processing on the target beautified result.

It can be understood that while the at least one beautified result is presented in the target chat interface, the at least one operation label is also presented, so that the user may select a required operation label from the at least one operation label to perform corresponding processing on the target beautified result, thereby improving the user experience.

In some embodiments of the present disclosure, chat content of the at least one user for the at least one beautified result and/or the at least one clipping result may also be presented in the target chat interface. The chat content may specifically include comment information and/or discussion information about the beautified result or the clipping result. This may be specifically determined based on an actual situation, which is not limited here.

In the embodiments of the present disclosure, by adding the material editing robot with a material editing function to the chat window, a user may send the material editing instruction in the target chat interface, so that the material editing robot edits the at least one material based on the material editing instruction to obtain at least one material editing result, and presents the at least one material editing result replied by the material editing robot in the target chat interface. In this way, when the user needs to edit a large number of materials shot on a certain shooting subject, there is no need to deeply analyze which materials can better express the shooting subject, and there is no need to manually find, from the at least one material, the target material required to be edited. This may reduce the time consumption. Moreover, a material editing result may be generated without the user manually performing a series of complex material editing operations on the target material, which can further reduce the time consumption. The user only needs to send the at least one shot material to the chat window, and send the material editing instruction in the target chat interface, to trigger the material editing robot to automatically edit the at least one material to obtain the at least one material editing result, thereby improving the efficiency of material editing and the quality of the material editing result.

In some embodiments of the present disclosure, after the foregoing step 103d, the method for material editing provided in the embodiments of the present disclosure may further include the following step 104.

104. In response to a trigger operation on a target operation label from the at least one operation label, the beautifying parameter corresponding to the target beautified result is stored as a target beautifying parameter for performing material processing on the target object.

The material processing comprises at least one of the following: material beautifying or material clipping.

The target operation label is configured to indicate storing the target beautified result of the at least one beautified result.

It can be understood that the material editing robot may store a beautifying parameter corresponding to the target beautified result, and may store the beautifying parameter corresponding to the target beautified result as an exclusive beautifying parameter of the target object, for subsequent use when it is necessary to perform beautifying on the target object.

In some embodiments of the present disclosure, the beautifying parameter may be stored in a local storage space corresponding to the target social application, or in a background server corresponding to the target social application, or may be stored in a server corresponding to the material editing robot. This may be specifically determined based on an actual situation, which is not limited here.

In the embodiments of the present disclosure, the at least one beautified result and the at least one operation label replied by the material editing robot are presented in the target chat interface, and then in response to the trigger operation on the target beautified result and the target operation label selected by the user from the at least one beautified result, the beautifying parameter corresponding to the target beautified result are stored as the target beautifying parameter for subsequent beautifying on the target object, to provide a choice for the user and allow the user to participate in it, so that the final beautifying effect may satisfy the user more, thereby improving the user experience.

In some embodiments of the present disclosure, after the foregoing step 104, the method for material editing provided in the embodiments of the present disclosure may further include the following steps 105 and 106.

105. In the target chat interface, a material clipping instruction for the target object sent by the user to the material editing robot is presented.

106. In the target chat interface, at least one material clipping result replied by the material editing robot is presented.

The at least one material clipping result is obtained by the material editing robot performing material clipping on the at least one material based on the material clipping instruction, and the target object in the at least one material clipping result has been beautified based on the target beautifying parameter.

A description of the at least one material clipping result may refer to the related description of the clipping result, and details are not described herein again.

It can be understood that as the target beautifying parameter corresponding to the target object is saved in step 104, when receiving the material clipping instruction for the target object, during a process of performing material clipping on the at least one material, the target object is beautified based on the target beautifying parameter, to obtain at least one material clipping result featuring the target object and has been beautified.

In some embodiments of the present disclosure, the material clipping instruction does not include an instruction for beautifying the target object, and the target beautifying parameter of the target object has not been stored before. In this case, during the process of performing material clipping by the material editing robot, the target object is not beautified or beautified in a general processing manner.

In some embodiments of the present disclosure, before the foregoing step 101, the method for material editing provided in the embodiments of the present disclosure may further include the following step 107.

107. In response to a trigger operation of a user to add the material editing robot to the chat window, in the target chat interface, a target message sent by the material editing robot is presented.

The target message comprises a function introduction of the material editing robot in a text form, and the target message further comprises at least one of the following:
a function introduction of the material editing robot in a video form; or
a question of the material editing robot about a chat topic of the target chat interface.

In the embodiments of the present disclosure, the user may add the material editing robot to the chat window by an operation of adding a chat member during a process of creating the chat window, or add the material editing robot to the chat window by an operation of adding a chat member in the chat window after the chat window is created. This may be specifically determined based on an actual situation, which is not limited here.

The chat topic may include topics of different chat types. For example, the chat topic may include “Family and friends”, “Gossip chat”, “Travel”, “Marketing and shopping guide”, or the like. This may be specifically determined based on an actual situation, which is not limited here.

In some embodiments of the present disclosure, the question of the material editing robot about the chat topic of the target chat interface may present options of a plurality of chat topics for the user to select, and may further include an option of “No topic”. This may be specifically determined based on an actual situation, which is not limited here.

In some embodiments of the present disclosure, the foregoing step 107 may be specifically implemented by the following steps 107a and 107b.

107a. In response to a trigger operation of the user adding the material editing robot to the chat window, a function setting interface of the material editing robot is presented.

In the function setting interface, information such as a nickname of the material editing robot, a function definition, and whether the material editing robot is visible to all users may be set. This may be specifically determined based on an actual situation, which is not limited here.

Information required to be configured in the function setting interface may be information that must be configured, or may be selectively configured. This may be specifically determined based on an actual situation, which is not limited here.

In some embodiments of the present disclosure, some settings in the function setting interface may be settings required to be entered by a user based on an actual situation (in this case, an input prompt may be set for the user to understand). Some settings may be settings including a plurality of selectable options, and a user needs to select a required option from the plurality of selectable options. The specific presenting content of the function setting interface may be determined based on an actual situation, which is not limited here.

107b. In response to a trigger operation of a first user on the function setting interface, a target message sent by the material editing robot is presented in the target chat interface.

In the embodiments of the present disclosure, by presenting the function setting interface of the material editing robot, a user can better understand the material editing robot and set the material editing robot that conforms to requirements of the user.

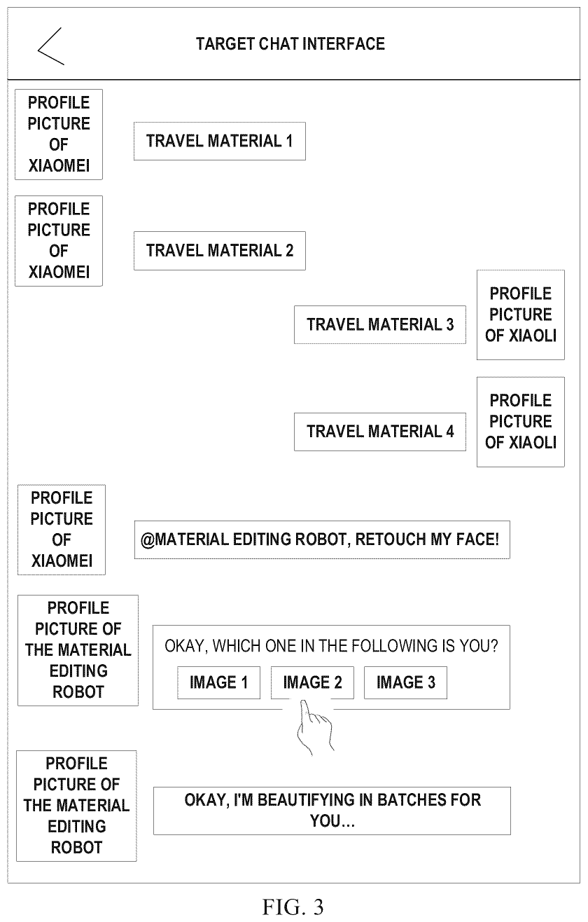

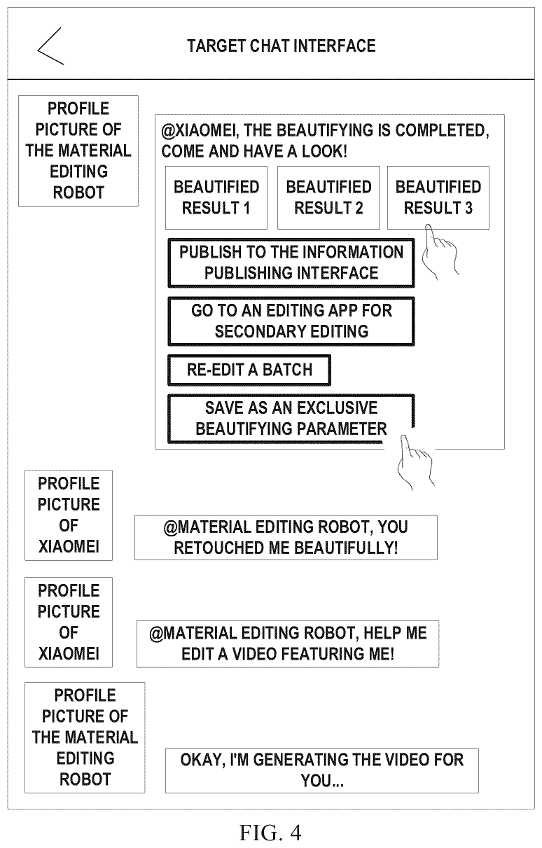

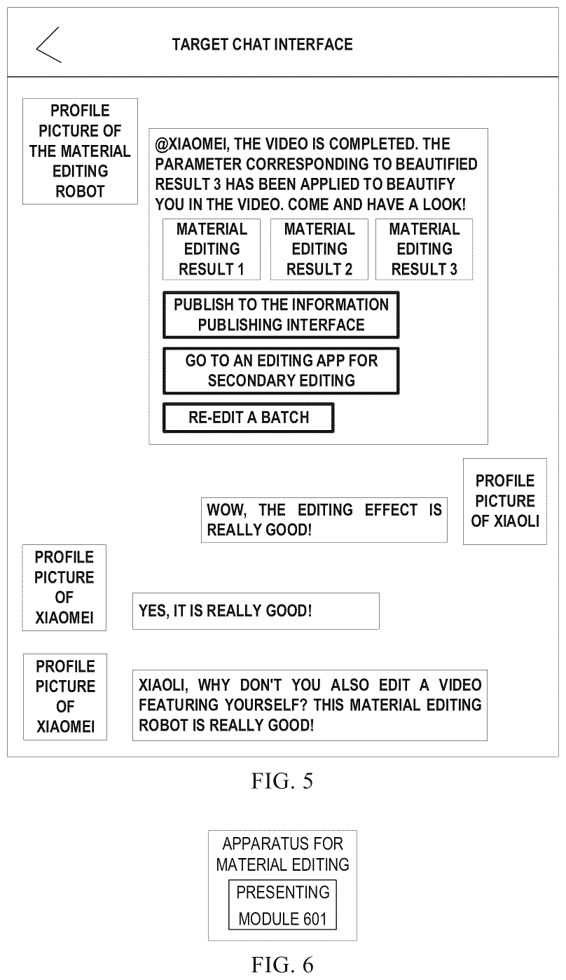

For example, the chat window is a group chat window that records travel, and the target object is Xiaomei. As shown in FIG. 2, after the material editing robot joins the chat window, the material editing robot prompts a user to select a chat topic in the target chat interface. As shown in FIG. 3, chat information may include a plurality of materials sent by Xiaomei and Xiaoli respectively, and a process in which Xiaomei sends an object beautifying instruction to the material editing robot and the material editing robot asks which one is Xiaomi. As shown in FIG. 4, after the material editing robot beautifying Xiaomei, a plurality of beautified results are presented. A beautifying parameter corresponding to a beautified result 3 is stored as the target beautifying parameter according to the beautified result selected by Xiaomei and a trigger operation on an operation label “Save as an exclusive beautifying parameter”, and then Xiaomei sends a material clipping instruction to the material editing robot. As shown in FIG. 5, FIG. 5 shows a plurality of material clipping results clipped by the material editing robot based on the material clipping instruction, and a discussion of Xiaomei and Xiaoli about the clipping effect of the plurality of material clipping results.

FIG. 6 is a block diagram of a structure of an apparatus for material editing according to an embodiment of the present disclosure. As shown in FIG. 6, the apparatus comprises a presenting module 601 configured to present a target chat interface, where the target chat interface is a chat window interface of a material editing robot and at least one user, the target chat interface comprises at least one material corresponding to the at least one user, and the at least one material is a material with a same shooting subject; present, in the target chat interface, a material editing instruction for the at least one material sent by a user to the material editing robot; and present, in the target chat interface, at least one material editing result replied by the material editing robot, where the at least one material editing result is obtained by the material editing robot editing the at least one material based on the material editing instruction.

In some embodiments of the present disclosure, the material editing instruction is an instruction for editing a target object; and the presenting module 601 is configured to present, in the target chat interface, a plurality of images and first prompt information replied by the material editing robot, where the first prompt information is configured to prompt a user to select, from the plurality of images, an image corresponding to the target object, and each image is an image comprising an object extracted by the material editing robot from the at least one material; and in response to a trigger operation of a user to select a target image corresponding to the target object, present the at least one material editing result.

In some embodiments of the present disclosure, the presenting module 601 is configured to, in response to a trigger operation of a user to select the target image corresponding to the target object, present, in the target chat interface, at least one candidate material and second prompt information replied by the material editing robot, where each candidate material is a material comprising the target object in the at least one material, and the second prompt information is configured to prompt the user to select, from the at least one candidate material, a material required to be edited; and in response to a trigger operation of a user to select the target material from the at least one candidate material, present the at least one material editing result, where the at least one material editing result is obtained by the material editing robot editing the target material.

In some embodiments of the present disclosure, the material editing instruction is a material clipping instruction, and the editing is material clipping, and the at least one material editing result is at least one clipping result; and the presenting module 601 is configured to present, in the target chat interface, the at least one clipping result and at least one operation identifier, where each operation identifier is configured to indicate any of the following: playing a target clipping result from the at least one clipping result; storing the target clipping result from the at least one clipping result; publishing the target clipping result from the at least one clipping result to an information publishing interface of a target social application; re-performing material clipping on the target object in the at least one material to generate a clipping result; or jumping to a video editing application to perform secondary editing on the target clipping result from the at least one clipping result.

In some embodiments of the present disclosure, the material editing instruction is an object beautifying instruction, and the editing is material beautifying, the at least one material editing result is at least one beautified result, the presenting module 601 is configured to present, in the target chat interface, the at least one beautified result and at least one operation label, where each operation label is configured to indicate any of the following: storing a target beautified result from the at least one beautified result; publishing the target beautified result from the at least one beautified result to an information publishing interface of a target social application; storing a beautifying parameter corresponding to the target beautified result from the at least one beautified result; re-performing material beautifying on the target object from the at least one material to generate a beautified result; or jumping to a video editing application to perform secondary editing on the target beautified result from the at least one beautified result.

In some embodiments of the present disclosure, the apparatus further comprises a storing module configured to, after presenting, in the target chat interface, the at least one beautified result and the at least one operation label, in response to a trigger operation on a target operation label from the at least one operation label, store the beautifying parameter corresponding to the target beautified result as a target beautifying parameter for performing material processing on the target object, where the material processing comprises at least one of the following: material beautifying or material clipping.

In some embodiments of the present disclosure, the presenting module 601 is further configured to, after storing the beautifying parameter corresponding to the target beautified result as the target beautifying parameter for performing material processing on the target object, present, in the target chat interface, a material clipping instruction for the target object sent by the user to the material editing robot; and present, in the target chat interface, at least one material clipping result replied by the material editing robot, where the at least one material clipping result is obtained by the material editing robot performing material clipping on the at least one material based on the material clipping instruction, and the target object in the at least one material clipping result has been beautified based on the target beautifying parameter.

In some embodiments of the present disclosure, the presenting module 601 is further configured to, before presenting the target chat interface, in response to a trigger operation of a user to add the material editing robot to the chat window, present, in the target chat interface, a target message sent by the material editing robot; where the target message comprises a function introduction of the material editing robot in a text form, and the target message further comprises at least one of the following: a function introduction of the material editing robot in a video form; or a question of the material editing robot about a chat topic of the target chat interface.

In the embodiments of the present disclosure, each module may implement the method for material editing provided in the method embodiments described above, and can achieve the same technical effect. To avoid repetition, details are not described herein again.

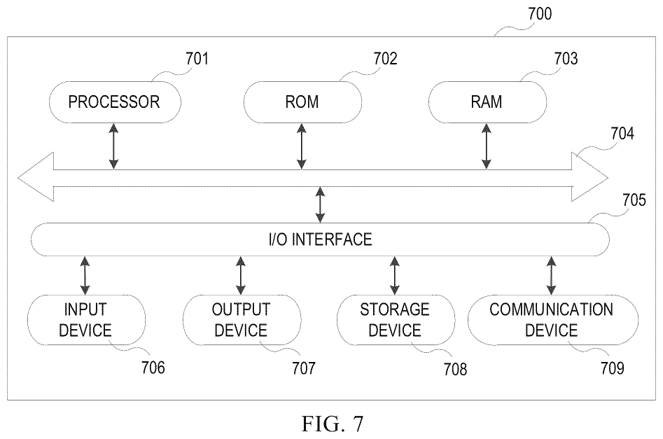

FIG. 7 is a schematic diagram of a structure of an electronic device according to an embodiment of the present disclosure, which is used to exemplarily illustrate an electronic device for implementing any method for material editing in the embodiments of the present disclosure, and should not be construed as a specific limitation on the embodiments of the present disclosure.

As shown in FIG. 7, an electronic device 700 may include a processor (for example, a central processing unit, a graphics processing unit, or the like) 701 that may perform a variety of appropriate actions and processing in accordance with a program stored in a read-only memory (ROM) 702 or a program loaded from a storage device 708 into a random access memory (RAM) 703. The RAM 703 further stores various programs and data required for the operation of the electronic device 700. The processor 701, the ROM 702, and the RAM 703 are connected to each other through a bus 704. An input/output (I/O) interface 705 is also connected to the bus 704.

Generally, the following devices may be connected to the I/O interface 705: an input device 706 including, for example, a touch screen, a touchpad, a keyboard, a mouse, a camera, a microphone, an accelerometer, and a gyroscope; an output device 707 including, for example, a liquid crystal display (LCD), a speaker, and a vibrator; the storage device 708 including, for example, a tape and a hard disk; and a communication device 709. The communication device 709 may allow the electronic device 700 to perform wireless or wired communication with other devices to exchange data. Although the electronic device 700 having various devices is shown, it should be understood that it is not required to implement or have all of the shown devices. It is an alternative to implement or have more or fewer devices.

In particular, according to an embodiment of the present disclosure, the process described above with reference to the flowchart may be implemented as a computer software program. For example, the embodiments of the present disclosure comprise a computer program product, which comprises a computer program carried on a non-transitory computer-readable medium. The computer program comprises program code for performing the method shown in the flowchart. In such an embodiment, the computer program may be downloaded from a network through the communication device 709 and installed, installed from the storage device 708, or installed from the ROM 702. When the computer program is executed by the processor 701, the functions defined in any of the method for material editing provided in the embodiments of the present disclosure may be performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, where the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained in the computer-readable medium may be transmitted by any suitable medium, including but not limited to: an electric wire, an optical cable, radio frequency (RF), or the like, or any suitable combination thereof.

In some implementations, a client and a server may communicate using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device; or may exist independently without being assembled into the electronic device.

The above computer-readable medium carries one or more programs, and when the one or more programs are executed by the electronic device, the electronic device is caused to: present a target chat interface, where the target chat interface is a chat window interface of a material editing robot and at least one user, the target chat interface comprises at least one material corresponding to the at least one user, and the at least one material is a material with a same shooting subject; present, in the target chat interface, a material editing instruction for the at least one material sent by a user to the material editing robot; and present, in the target chat interface, at least one material editing result replied by the material editing robot, where the at least one material editing result is obtained by the material editing robot editing the at least one material based on the material editing instruction.

In the embodiments of the present disclosure, the computer program code for performing the operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer, partially executed on a computer, executed as an independent software package, partially executed on a computer and partially executed on a remote computer, or completely executed on a remote computer or server. In the case involving the remote computer, the remote computer may be connected to a computer through any kind of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions labeled in the blocks may also occur in an order different from that labeled in the accompanying drawings. For example, two blocks shown in succession may actually be performed substantially in parallel, or they may sometimes be performed in a reverse order, depending on the functions involved. It should also be noted that each block in the block diagram and/or the flowchart, and a combination of the blocks in the block diagram and/or the flowchart may be implemented by a dedicated hardware-based system that performs specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases.

The functions described herein above may be performed at least partially by one or more hardware logic components. For example, without limitation, example types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a computer-readable medium may be a tangible medium that may contain or store a program used by or in combination with an instruction execution system, apparatus, or device. The computer-readable medium may be a computer-readable signal medium or a computer-readable storage medium. The computer-readable medium may include, but is not limited to, electronic, magnetic, optical, electromagnetic, infrared, or semiconductor systems, apparatuses, or devices, or any suitable combination thereof. A more specific example of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The foregoing descriptions are merely preferred embodiments of the present disclosure and illustrations of the applied technical principles. A person skilled in the art should understand that the scope of disclosure involved in the present disclosure is not limited to the technical solution formed by a specific combination of the foregoing technical features, and should also cover other technical solutions formed by any combination of the foregoing technical features or equivalent features thereof without departing from the foregoing concept of disclosure. For example, a technical solution formed by replacing the foregoing features with technical features with similar functions disclosed in the present disclosure (but not limited to).

In addition, although the various operations are depicted in a specific order, it should not be understood as requiring these operations to be performed in the specific shown order or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A method for material editing, comprising:
presenting a target chat interface, wherein the target chat interface is a chat window interface of a material editing robot and at least one user, the target chat interface comprises at least one material corresponding to the at least one user, and the at least one material is a material with a same shooting subject;
presenting, in the target chat interface, a material editing instruction for the at least one material sent by a user to the material editing robot; and
presenting, in the target chat interface, at least one material editing result replied by the material editing robot, wherein the at least one material editing result is obtained by the material editing robot editing the at least one material based on the material editing instruction.

2. The method of claim 1, wherein the material editing instruction is an instruction for editing a target object; and presenting, in the target chat interface, at least one material editing result replied by the material editing robot comprises:
presenting, in the target chat interface, a plurality of images and first prompt information replied by the material editing robot, wherein the first prompt information is configured to prompt a user to select, from the plurality of images, an image corresponding to the target object, and each image is an image comprising an object extracted by the material editing robot from the at least one material; and
in response to a trigger operation of a user to select a target image corresponding to the target object, presenting the at least one material editing result.

3. The method of claim 2, wherein in response to the trigger operation of the user to select the target image corresponding to the target object, presenting the at least one material editing result comprises:
in response to a trigger operation of a user to select the target image corresponding to the target object, presenting, in the target chat interface, at least one candidate material and second prompt information replied by the material editing robot, wherein each candidate material is a material comprising the target object in the at least one material, and the second prompt information is configured to prompt the user to select, from the at least one candidate material, a material required to be edited; and
in response to a trigger operation of a user to select the target material from the at least one candidate material, presenting the at least one material editing result, wherein the at least one material editing result is obtained by the material editing robot editing the target material.

4. The method of claim 1, wherein the material editing instruction is a material clipping instruction, and the editing is material clipping, and the at least one material editing result is at least one clipping result; and presenting, in the target chat interface, at least one material editing result replied by the material editing robot comprises:
presenting, in the target chat interface, the at least one clipping result and at least one operation identifier, wherein each operation identifier is configured to indicate any of the following:
playing a target clipping result from the at least one clipping result;
storing the target clipping result from the at least one clipping result;
publishing the target clipping result from the at least one clipping result to an information publishing interface of a target social application;
re-performing material clipping on the target object in the at least one material to generate a clipping result; or
jumping to a video editing application to perform secondary editing on the target clipping result from the at least one clipping result.

5. The method of claim 1, wherein the material editing instruction is an object beautifying instruction, and the editing is material beautifying, the at least one material editing result is at least one beautified result, and presenting, in the target chat interface, the at least one material editing result replied by the material editing robot comprises:
presenting, in the target chat interface, the at least one beautified result and at least one operation label, wherein each operation label is configured to indicate any of the following:
storing a target beautified result from the at least one beautified result;
publishing the target beautified result from the at least one beautified result to an information publishing interface of a target social application;
storing a beautifying parameter corresponding to the target beautified result from the at least one beautified result;
re-performing material beautifying on the target object from the at least one material to generate a beautified result; or
jumping to a video editing application to perform secondary editing on the target beautified result from the at least one beautified result.

6. The method of claim 5, wherein after presenting, in the target chat interface, the at least one beautified result and the at least one operation label, the method further comprises:
in response to a trigger operation on a target operation label from the at least one operation label, storing the beautifying parameter corresponding to the target beautified result as a target beautifying parameter for performing material processing on the target object, wherein the material processing comprises at least one of the following: material beautifying or material clipping.

7. The method of claim 6, wherein after storing the beautifying parameter corresponding to the target beautified result as the target beautifying parameter for performing material processing on the target object, the method further comprises:
presenting, in the target chat interface, a material clipping instruction for the target object sent by the user to the material editing robot; and
presenting, in the target chat interface, at least one material clipping result replied by the material editing robot, wherein the at least one material clipping result is obtained by the material editing robot performing material clipping on the at least one material based on the material clipping instruction, and the target object in the at least one material clipping result has been beautified based on the target beautifying parameter.

8. The method of claim 1, wherein before presenting the target chat interface, the method further comprises:
in response to a trigger operation of a user to add the material editing robot to the chat window, presenting, in the target chat interface, a target message sent by the material editing robot;
wherein the target message comprises a function introduction of the material editing robot in a text form, and the target message further comprises at least one of the following:
a function introduction of the material editing robot in a video form; or
a question of the material editing robot about a chat topic of the target chat interface.

9. An electronic device, comprising: a memory and a processor, wherein the memory is configured to store a computer program; and the processor is configured to perform operations comprising:
presenting a target chat interface, wherein the target chat interface is a chat window interface of a material editing robot and at least one user, the target chat interface comprises at least one material corresponding to the at least one user, and the at least one material is a material with a same shooting subject;
presenting, in the target chat interface, a material editing instruction for the at least one material sent by a user to the material editing robot; and
presenting, in the target chat interface, at least one material editing result replied by the material editing robot, wherein the at least one material editing result is obtained by the material editing robot editing the at least one material based on the material editing instruction.

10. The electronic device of claim 9, wherein the material editing instruction is an instruction for editing a target object; and presenting, in the target chat interface, at least one material editing result replied by the material editing robot comprises:
presenting, in the target chat interface, a plurality of images and first prompt information replied by the material editing robot, wherein the first prompt information is configured to prompt a user to select, from the plurality of images, an image corresponding to the target object, and each image is an image comprising an object extracted by the material editing robot from the at least one material; and
in response to a trigger operation of a user to select a target image corresponding to the target object, presenting the at least one material editing result.

11. The electronic device of claim 10, wherein in response to the trigger operation of the user to select the target image corresponding to the target object, presenting the at least one material editing result comprises:
in response to a trigger operation of a user to select the target image corresponding to the target object, presenting, in the target chat interface, at least one candidate material and second prompt information replied by the material editing robot, wherein each candidate material is a material comprising the target object in the at least one material, and the second prompt information is configured to prompt the user to select, from the at least one candidate material, a material required to be edited; and
in response to a trigger operation of a user to select the target material from the at least one candidate material, presenting the at least one material editing result, wherein the at least one material editing result is obtained by the material editing robot editing the target material.

12. The electronic device of claim 9, wherein the material editing instruction is a material clipping instruction, and the editing is material clipping, and the at least one material editing result is at least one clipping result; and presenting, in the target chat interface, at least one material editing result replied by the material editing robot comprises:
presenting, in the target chat interface, the at least one clipping result and at least one operation identifier, wherein each operation identifier is configured to indicate any of the following:
playing a target clipping result from the at least one clipping result;
storing the target clipping result from the at least one clipping result;
publishing the target clipping result from the at least one clipping result to an information publishing interface of a target social application;
re-performing material clipping on the target object in the at least one material to generate a clipping result; or
jumping to a video editing application to perform secondary editing on the target clipping result from the at least one clipping result.

13. The electronic device of claim 9, wherein the material editing instruction is an object beautifying instruction, and the editing is material beautifying, the at least one material editing result is at least one beautified result, and presenting, in the target chat interface, the at least one material editing result replied by the material editing robot comprises:
presenting, in the target chat interface, the at least one beautified result and at least one operation label, wherein each operation label is configured to indicate any of the following:
storing a target beautified result from the at least one beautified result;
publishing the target beautified result from the at least one beautified result to an information publishing interface of a target social application;
storing a beautifying parameter corresponding to the target beautified result from the at least one beautified result;
re-performing material beautifying on the target object from the at least one material to generate a beautified result; or
jumping to a video editing application to perform secondary editing on the target beautified result from the at least one beautified result.

14. The electronic device of claim 13, wherein after presenting, in the target chat interface, the at least one beautified result and the at least one operation label, the method further comprises:
in response to a trigger operation on a target operation label from the at least one operation label, storing the beautifying parameter corresponding to the target beautified result as a target beautifying parameter for performing material processing on the target object, wherein the material processing comprises at least one of the following: material beautifying or material clipping.

15. The electronic device of claim 14, wherein after storing the beautifying parameter corresponding to the target beautified result as the target beautifying parameter for performing material processing on the target object, the method further comprises:
presenting, in the target chat interface, a material clipping instruction for the target object sent by the user to the material editing robot; and
presenting, in the target chat interface, at least one material clipping result replied by the material editing robot, wherein the at least one material clipping result is obtained by the material editing robot performing material clipping on the at least one material based on the material clipping instruction, and the target object in the at least one material clipping result has been beautified based on the target beautifying parameter.

16. The method of claim 9, wherein before presenting the target chat interface, the method further comprises:
In response to a trigger operation of a user to add the material editing robot to the chat window, presenting, in the target chat interface, a target message sent by the material editing robot;
wherein the target message comprises a function introduction of the material editing robot in a text form, and the target message further comprises at least one of the following:
a function introduction of the material editing robot in a video form; or
a question of the material editing robot about a chat topic of the target chat interface.

17. A non-transitory computer-readable storage medium, having a computer program stored thereon which, when executed by a processor, performs operations comprising:
presenting a target chat interface, wherein the target chat interface is a chat window interface of a material editing robot and at least one user, the target chat interface comprises at least one material corresponding to the at least one user, and the at least one material is a material with a same shooting subject;
presenting, in the target chat interface, a material editing instruction for the at least one material sent by a user to the material editing robot; and
presenting, in the target chat interface, at least one material editing result replied by the material editing robot, wherein the at least one material editing result is obtained by the material editing robot editing the at least one material based on the material editing instruction.

18. The medium of claim 17, wherein the material editing instruction is an instruction for editing a target object; and presenting, in the target chat interface, at least one material editing result replied by the material editing robot comprises:
presenting, in the target chat interface, a plurality of images and first prompt information replied by the material editing robot, wherein the first prompt information is configured to prompt a user to select, from the plurality of images, an image corresponding to the target object, and each image is an image comprising an object extracted by the material editing robot from the at least one material; and
in response to a trigger operation of a user to select a target image corresponding to the target object, presenting the at least one material editing result.

19. The medium of claim 18, wherein in response to the trigger operation of the user to select the target image corresponding to the target object, presenting the at least one material editing result comprises:
in response to a trigger operation of a user to select the target image corresponding to the target object, presenting, in the target chat interface, at least one candidate material and second prompt information replied by the material editing robot, wherein each candidate material is a material comprising the target object in the at least one material, and the second prompt information is configured to prompt the user to select, from the at least one candidate material, a material required to be edited; and
in response to a trigger operation of a user to select the target material from the at least one candidate material, presenting the at least one material editing result, wherein the at least one material editing result is obtained by the material editing robot editing the target material.

20. The medium of claim 17, wherein the material editing instruction is a material clipping instruction, and the editing is material clipping, and the at least one material editing result is at least one clipping result; and presenting, in the target chat interface, at least one material editing result replied by the material editing robot comprises:
presenting, in the target chat interface, the at least one clipping result and at least one operation identifier, wherein each operation identifier is configured to indicate any of the following:
playing a target clipping result from the at least one clipping result;
storing the target clipping result from the at least one clipping result;
publishing the target clipping result from the at least one clipping result to an information publishing interface of a target social application;
re-performing material clipping on the target object in the at least one material to generate a clipping result; or
jumping to a video editing application to perform secondary editing on the target clipping result from the at least one clipping result.
